(19) United States
(12) Patent Application Publication
(10) Pub. No.: US 2025/0122390 A1
(43) Pub. Date: Apr. 17, 2025

(54) POLYOLEFIN-BASED FORMULATIONS FOR ADDITIVE MANUFACTURING

(71) Applicant: Lawrence Livermore National Security, LLC, Livermore, CA (US)

(72) Inventors: Thomas S. Wilson, San Leandro, CA (US); Alexandra Melody Golobic, Pleasanton, CA (US); Jeremy M. Lenhardt, Livermore, CA (US); Spencer Schmidt, Oakland, CA (US)

(21) Appl. No.: 18/987,598

(22) Filed: Dec. 19, 2024

Related U.S. Application Data
(63) Continuation-in-part of application No. 17/098,109, filed on Nov. 13, 2020.

(51) Int. Cl. C09D 11/108; B29C 64/124; B33Y 70/10; C09D 11/037

(52) U.S. Cl. CPC C09D 11/108; B29C 64/124; B33Y 70/10; C09D 11/037

(57) ABSTRACT

A polyolefin-based ink for additive manufacturing includes a polyolefin comprising at least one type of functional group for crosslinking, where the polyolefin includes at least an ethylene monomeric unit and at least a propylene monomeric unit. The ethylene monomeric unit is present in a range of greater than 50 wt. % to about 75 wt. % of a total weight of the polyolefin. Moreover, the polyolefin has a molecular weight that is no more than five times the entanglement molecular weight of a homologous series of the polyolefin.

### RELATED APPLICATIONS

This application is a Continuation-in-Part of U.S. application Ser. No. 17/098,109 filed Nov. 13, 2020, which is herein incorporated by reference.

This invention was made with Government support under Contract No. DE-AC52-07NA27344 awarded by the United States Department of Energy. The Government has certain rights in the invention.

### FIELD OF THE INVENTION

The present invention relates to additive manufacturing of polyolefin materials, and more particularly, this invention relates to polyolefin-based inks and additive manufacturing processes using such inks.

### BACKGROUND

Additive manufacturing technology is a promising new venture wherein there have been noted time savings for production, cost savings on materials and time and possible metamaterials applications. In particular, direct ink writing (DIW) is a micro-extrusion technique where a printable ink is deposited in a layer-by-layer fashion to build up an object.

Recent contemplated approaches have demonstrated the flowable nature of liquid siloxane materials may be used in a DIW process of additive manufacturing (AM) where the resulting formed three-dimensional (3D) structures retain their shape using methodology disclosed in U.S. patent application Ser. No. 15/721,528 which is herein incorporated by reference. Thus, recent advances in additive manufacturing of rubber material has resulted in the capability of rapidly and reliably producing products of complex structure. However, conventional manufacturing methods such as rubber molding and foam production are limited by: the geometry/structure of the products that can be produced, the high cost of small batch sizes, ability to interchangeably produce different parts, little control over pore distribution in porous materials, waste produced by parts that must be manually cut from a bulk material, etc.

With changing needs for products used in different industries, there is an increasing need for the ability to cost effectively produce rubber materials at research and industrial scales without the limitations of conventional manufacturing.

The recent field of 3D printing has become a favorable alternative. DIW is a particularly advantageous method of 3D printing as it prints viscoelastic materials into planar and 3D structures at ambient conditions. Further, the material is fully formed into its final part geometry prior to cure, eliminating the weak boundaries between layers which can limit other additive manufacturing processes. The utility of DIW for rubber production has previously been demonstrated with silicone-based ink formulated with vinyl-terminated siloxane macromer, reinforcing fillers, and rheology modifying additives.

In those previous inventions, DIW inks were formulated based on siloxane chemistry in order to achieve elastomeric materials. Siloxanes have excellent low temperature mechanical behavior, are highly versatile for variable stiffness, filler loading, high temperature stable, and chemically stable under neutral conditions. However, siloxane materials have relatively low strength as compared to typical polyolefin-based elastomers and poor aging behavior when subjected to highly acidic or basic environments. Siloxanes are also quite expensive, preventing their use in many applications.

### SUMMARY

According to one embodiment, a polyolefin-based ink for additive manufacturing includes a polyolefin comprising at least one type of functional group for crosslinking, where the polyolefin includes at least an ethylene monomeric unit and at least a propylene monomeric unit. The ethylene monomeric unit is present in a range of greater than 50 wt. % to about 75 wt. % of a total weight of the polyolefin. Moreover, the polyolefin has a molecular weight that is no more than five times the entanglement molecular weight of a homologous series of the polyolefin.

According to another embodiment, a polyolefin-based ink for additive manufacturing includes a polyolefin having a molecular weight that is no more than 5× the entanglement molecular weight of a homologous series of the polyolefin. The molecular weight may be calculated using one of the techniques following techniques: number average molecular weight, weight average molecular weight, or Z-average molar mass. Moreover, the ink has a crystallization temperature in a range of about 40° C. to about 60° C.

Other aspects and advantages of the present invention will become apparent from the following detailed description, which, when taken in conjunction with the drawings, illustrate by way of example the principles of the invention.

### BRIEF DESCRIPTIONS OF DRAWINGS

FIG. 1 is a schematic diagram of structures of polyolefins, according to one embodiment.

FIG. 2 is a schematic diagram of polyolefin-based product, according to various embodiments. Part (a) is schematic diagram of an extruded polyolefin-based product, part (b) is a schematic diagram of a bulk polyolefin-based product.

FIG. 3 is a flowchart of a method, according to one embodiment.

FIG. 4 is a plot of molecular weight dependence on zero shear viscosity.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified.

As also used herein, the term “about” denotes an interval of accuracy that ensures the technical effect of the feature in question. In various approaches, the term “about” when combined with a value, refers to plus and minus 10% of the reference value. For example, a thickness of about 10 nm refers to a thickness of 10 nm+1 nm, a temperature of about 50° C. refers to a temperature of 50° C.±5° C., etc.

It is noted that ambient room temperature may be defined as a temperature in a range of about 20° C. to about 25° C.

It is also noted that, as used in the specification and the appended claims, wt. % is defined as the percentage of weight of a particular component is to the total weight/mass of the mixture. Vol. % is defined as the percentage of volume of a particular compound to the total volume of the mixture or compound. Mol. % is defined as the percentage of moles of a particular component to the total moles of the mixture or compound. Atomic % (at. %) is defined as a percentage of one type of atom relative to the total number of atoms of a compound.

Unless expressly defined otherwise herein, each component listed in a particular approach may be present in an effective amount. An effective amount of a component means that enough of the component is present to result in a discernable change in a target characteristic of the ink, printed structure, and/or final product in which the component is present, and preferably results in a change of the characteristic to within a desired range. One skilled in the art, now armed with the teachings herein, would be able to readily determine an effective amount of a particular component without having to resort to undue experimentation.

The present disclosure includes several descriptions of exemplary “inks” used in an additive manufacturing process to form the inventive structures described herein. It should be understood that “inks” (and singular forms thereof) may be used interchangeably and refer to a composition of matter comprising a plurality of particles coated with/dispersed throughout a liquid phase such that the composition of matter may be “written,” extruded, printed, or otherwise deposited to form a layer that substantially retains its extruded shape as-deposited geometry and does not experience significant sag, slump, or other deformation across spanning features on deposited layers and/or the printing platform, even when deposited onto other layers of ink, and/or when other layers of ink are deposited onto the layer. As such, skilled artisans will understand the presently described inks to exhibit appropriate rheological properties to allow the formation of monolithic structures via deposition of multiple layers of strands of the ink (or in some cases multiple inks with different compositions) in sequence and retain their printed shape and the shape of the overall printed structure for prolonged periods of time prior to curing.

The following description discloses several preferred structures formed via direct ink writing (DIW), extrusion freeform fabrication, or other equivalent techniques and which therefore exhibit unique structural and compositional characteristics conveyed via the precise control allowed by such techniques. DIW involves the forcing of an “ink” or paste-like material through a nozzle while creating a relative movement between the nozzle and a substrate beneath the nozzle, which movement causes the strand to form a pattern on the substrate. Parts are printed by layering the strands into a three-dimensional (3D) object, with or without porosity. The part retains a microstructure formed during printing due to a complex thixotropic rheology of the ink. The ink is then cured either during or post printing to form a permanent shape.

The following description discloses several preferred embodiments of polyolefin-based formulations for forming elastomeric three-dimensional structures and/or related systems and methods.

In one general embodiment, a polyolefin-based ink for additive manufacturing includes a polyolefin comprising at least one type of functional group for crosslinking, where the polyolefin includes at least an ethylene monomeric unit and at least a propylene monomeric unit. The ethylene monomeric unit is present in a range of greater than 50 wt. % to about 75 wt. % of a total weight of the polyolefin. Moreover, the polyolefin has a molecular weight that is no more than five times the entanglement molecular weight of a homologous series of the polyolefin.

In another general embodiment, a polyolefin-based ink for additive manufacturing includes a polyolefin having a molecular weight that is no more than 5× the entanglement molecular weight of a homologous series of the polyolefin. The molecular weight may be calculated using one of the techniques following techniques: number average molecular weight, weight average molecular weight, or Z-average molar mass. Moreover, the ink has a crystallization temperature in a range of about 40° C. to about 60° C.

A list of acronyms used in the description is provided below.
3D Three-dimensional
AM Additive manufacturing
C Celsius
DIW Direct Ink Writing
EPDM ethylene-propylene-diene monomer
Mₑ entanglement molecular weight
MW molecular weight
Pa Pascals
ppm parts per million
Pt Platinum
ROMP ring opening metathesis polymerization
T_{g} Glass transition temperature
wt. % weight percent

Inks with a specific rheology used in direct ink write 3D printing allow the resulting 3D printed structures to retain their shape for an extended period of time before curing. Materials designed for additive manufacturing processes result in printed viscoelastic materials at mild conditions, namely direct ink writing (DIW). DIW involves extrusion of paste-like material through a micronozzle that creates a pattern to the strand. Parts are printed by layering the strands into a 3D object, with or without porosity. The part retains a microstructure formed during printing due to a complex thixotropic rheology of the ink. The ink may then be cured either during or post printing to form a permanent shape.

In recent developments, siloxane-based inks with appropriate rheological behavior for 3D printing result in printing 3D structures with controlled architectures. Various embodiments described herein demonstrate a capability to tune the stiffness of printable polyolefin-based materials by controlling the chemistry, network formation, and crosslink density of siloxane-based ink formulations in order to overcome the challenging interplay between ink development, post-processing, material properties, and performance. Various embodiments described herein identify polyolefin-based ink and methods by which to prepare custom-tailored 3D printable polyolefin materials through extrusion-based direct ink writing (DIW) processes. The 3D printed polyolefin materials may be cured to form porous and nonporous materials.

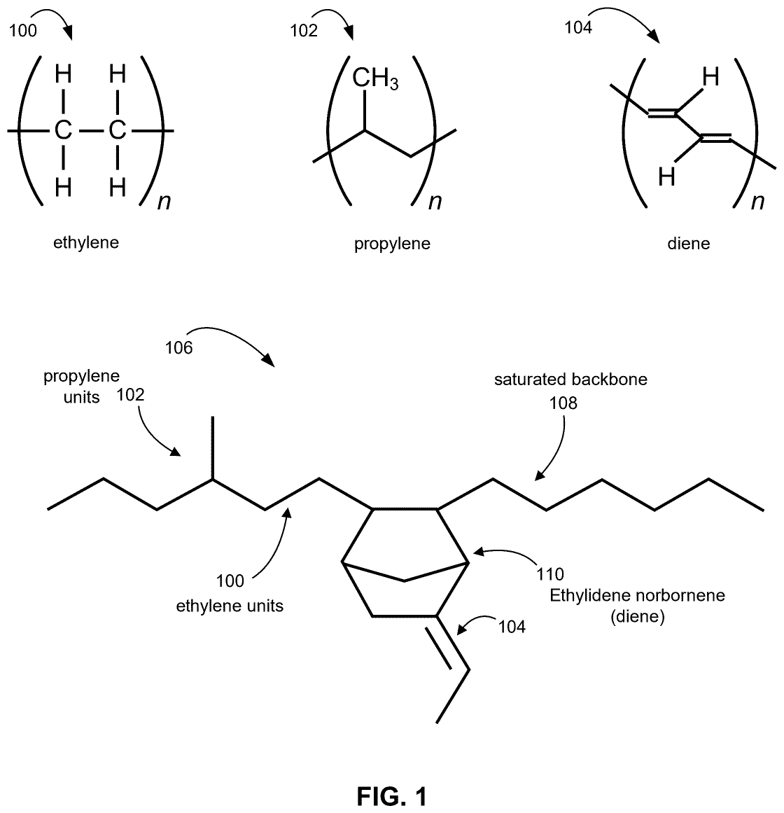

Various embodiments described herein utilize less expensive, versatile polyolefins as the network polymers for new DIW inks. A polyolefin is a type of polymer having at least one simple olefin (e.g., alkene with a general formula CₙH₂ₙ) as a monomer. For the purposes of this disclosure, polyolefin refers to both polyolefin homopolymers and polyolefin copolymers, where a copolymer contains two or more monomer species. FIG. 1 illustrates different polyolefins. Of particular interest are polyolefin-based inks that include ethylene-propylene comonomers. As illustrated in FIG. 1, multiple units (e.g., n units) of the monomeric unit ethylene 100 may form the monomer polyethylene, multiple units n of the monomeric unit propylene 102 may form the monomer polypropylene, and multiple units n of the monomeric unit diene 104 may form a polydiene. A polyolefin may include a combination of monomers. For example, a polyolefin such as ethylene-propylene-diene monomer (EPDM) 106 includes a monomeric units of ethylene 100, propylene 102, and diene 104. In one case the diene 104 is part of a larger molecule ethylidene norbornene (ENB) 110 of EPDM 106. Notably, a polyolefin, as shown with EPDM 106, includes a saturated backbone 108 comprised of ethylene units 100.

Rubbers, such as EPDM, have become widely used in a number of applications including construction, sealing, coatings, and other consumer applications. For example, as described herein, an ethylene-propylene-based ink, e.g., EPDM, may be optimized as a polyolefin-based ink. As illustrated in FIG. 1, the structure of EPDM 106 is comprised of mostly of monomeric units of ethylene 100 and propylene 102, and with a small weight fraction of the monomeric unit diene 104 present on polymer chain ends and/or sparsely dispersed along the chain.

A polyolefin, as illustrated in EPDM 106, may be tailored to be amorphous or have some degree of crystallinity by tuning the comonomer composition and the sequence distribution of the comonomers in the polymer chains. For example, the number and length of main chain segments containing ethylene are controlled through addition of propylene and diene to disrupt ethylene segment crystallization. Thus, a degree of crystallinity of a polyolefin may be tailored by tuning the frequency of propylene units in a polymer chain to interrupt the organization ethylene segments. For example, partially crystalline EPDM includes consistently repeating segments of three or more ethylene units. Alternately, the composition of EPDM may be engineered to result in a formulation of an amorphous EPDM. For example, decreasing crystallinity of an EPDM polymer may include separating ethylene sequences with propylene units, disrupting the regularity of perfectly alternating ethylene propylene monomers, certain periodic distribution of propylene units, etc.

The molecular weight of a polyolefin may affect the rheology of a polyolefin-based ink. According to one embodiment, polyolefins are linear or branched oligomers, preferably with molecular weights near or less than their entanglement molecular weight. It is important that the polyolefin oligomers have molecular weight near or below entanglement molecular weight to provide for a low viscosity and minimize elasticity in the material. This allows for the formulation of inks which have a Bingham type (paste-like) rheology with low apparent viscosity and sufficient yield stress thereby enabling the ink to flow through small nozzles in a plug flow manner, without excessive pressure build up or “die swell” behavior, and with the ability to retain printed shape until cured. As described herein, distribution of monomer units along a polyolefin backbone affects crystallinity, glass transition, viscosity, degree of cross-linking.

As described herein, engineered polyolefins and the associated formulations may be used as DIW printable inks having advantages such as low cost, highly versatility, excellent retention of physical characteristics and mechanical properties over time, etc. Physical and mechanical properties of the polyolefin materials described herein include tailored stiffness, chemically resistant, radiation resistant, hydrophobicity, etc. Moreover, these materials may be designed with a low temperature capability having low temperature transitions allowing the material to retain its elastomeric behavior in cold applications.

As described herein, polyolefin-based inks may be printed via DIW into materials with complex and highly controlled structures (e.g., structures having uniform porosity, uniform features, uniform density, etc.). For example, structures printed using polyolefin-based ink include highly uniform porous foam rubbers having tailored porosity, varied porosity, a gradient of porosity along at least a portion thereof, and/or stiffness, directionally controlled properties, etc.

A polyolefin may have a molecular weight that is less than 5 times its entanglement molecular weight. Methods for determining the entanglement molecular weight (Me) for a series of homologous polymers are well known to polymer scientists in the art. A series of homologous polymers are polymers exhibiting consistent monomer structure and distributions but differ in molecular weight. For the purposes of this disclosure, the entanglement molecular weight for a series of homologous polymers is determined based on the measurements of their zero shear viscosities, where the sample set includes polymers above and below the subsequently derived entanglement molecular weight. Calculation of the critical molecular weight (M_{c}) provides a quantitative aspect of the rheology of a given species of polymer. The critical molecular weight correlates empirically with the entanglement molecular weight. Said another way, the magnitude of the viscosity and elastic compliance determines the critical molecular weight for entanglement to occur M_{c} is typically larger than Mₑ, such that Mₑ is roughly 0.5×M_{c}.

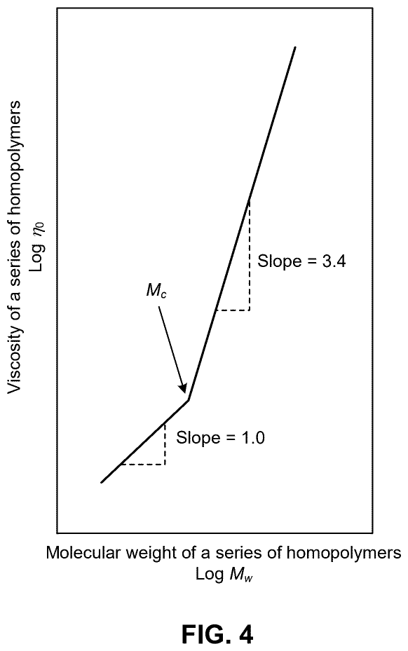

According to one embodiment, calculation of the entanglement molecular weight Mₑ correlates to the calculation of critical molecular weight M_{c} of a series of homologous polymers. As illustrated in FIG. 4, a well-known calculation of M_{c} includes the piece-wise relationship of zero shear viscosity η₀ and weight average molecular weight M_{w} for a series of homologous polymers. In the empirical (M_{w}, η₀) data plot, two behaviors are observed on either side of an inflection point: below the inflection point, η₀ increases linearly with increasing M_{w} (η₀∝M_{w}) and above the inflection point, η₀ increases with increasing M_{w} by an exponential factor of 3.4 (η₀∝M_{w}^{3.4}). A linear regression is fitted to the former group of data points and an exponential function raised to the power of 3.4 is fitted to the latter group of data points. The point of intersection for the two fits is taken as the critical molecular weight, M_{c}. Entanglement molecular weight, Mₑ, may be based on the relation for equilibrium modulus such that M_{c} tends to be larger than Mₑ for a series of homologous polymers. It is generally well understood by polymer scientists that

$${M}_{c} \approx 2 * {M}_{e} , such that$$

$${M}_{e} \approx {M}_{e} / 2$$

Polymers having a number average molecular weight below Me provide a limit of entropic-based elasticity of polymer chains during flow as well as provide a limit to the effective viscosity of the boundary layer for flow through the capillary nozzle during the DIW process.

Entanglement molecular weight Mₑ may be approximated in theoretical terms from tensile strength, from plateau modulus, etc. Each of these methods may be used to calculate a Mₑ that is about half the M_{c}. However, empirical methods such as that described above are preferred for more accurate determinations of entanglement molecular weight in real polymer systems.

A molecular weight of a polyolefin may be calculated using any technique known to those skilled in the art. The technique of calculating the molecular weight of the polyolefin may be selected based on chemistry and the type of polyolefin. The relationship of the molecular weight of a polyolefin and its entanglement molecular weight is relatively independent of the moment (i) of molecular weight used; that is, number average (i=1) Mₙ, weight average (i=2) M_{w}, Z-average molar mass (i=3) M_{z}, or higher order moments determined from the below equation may be used:

$${〈 M 〉}_{i} = \frac{{\sum }_{j} ( {M}_{j}^{i} * {n}_{j} )}{{\sum }_{j} ( {M}_{j}^{i - 1} * {n}_{j} )}$$

Where [symbol] M [symbol] ᵢ is the molecular weight of the polymer according to moment i of molecular weight, Mⱼ is the weight of a chain, nⱼ is the number of chains of that weight. Viscosity average molecular weight Mᵥ may not be preferred as a technique to determine molecular weight of a polyolefin. An Mᵥ calculation is generally applied to dilute polymer systems in a solvent rather than neat polymer and thus the equation for determining Mᵥ includes additional necessary parameters.

In another approach, a polyolefin preferably has a low polydispersity index (PDI) (where PDI is defined as the ratio of weight average molecular weight to number average molecular weight), for instance, in a range of less than 1.5, and preferably less than 1.3. A polyolefin having a PDI greater than 1.5 may have a broad distribution of individual chain sizes.

According to one embodiment, Mₑ is the entanglement molecular weight, measured by a number of techniques including that based on zero shear viscosity. In one approach, where Mₙ is the number average molecular weight, a polyolefin preferably has a Mₙ<5*Me, better Mₙ<2*Mₑ. In another approach, where M_{w} is the weight (mass) average molecular weight, a polyolefin preferably has a M_{w}<5*Mₑ, better M_{w}<2*Mₑ. In yet another approach, where M_{z} is the Z-average molar mass, a polyolefin preferably has a M_{z}<5*Mₑ, better M_{z}<2*Mₑ. Preferably, the polyolefin has a molecular weight that is no more than 5 times the entanglement molecular weight of a homologous series of a given polyolefin. In an exemplary approach, the polyolefin has a molecular weight that is no more than 2 times the entanglement molecular weight of a homologous series of the polyolefin. In other words, the polyolefin has a molecular weight that is similar to its critical molecular weight.

In various approaches, a range of polyolefins may have measurably different entanglement molecular weights given the range of monomer types included in the polyolefin. Moreover, different polyolefins will contain different monomer species and/or different distributions of monomer species, any case of which will impact the measured viscosities for a homologous series of a given polyolefin. Preferably, for each homologous series of polyolefin, an exemplary polyolefin has a molecular weight less than 5 times the entanglement molecular weight Mₑ of its homologous series. Alternatively, a polyolefin having a molecular weight greater than 5 times the entanglement molecular weight Mₑ of its homologous polymer series would not have a viscosity preferable to function as a flowable component in an ink for extrusion-based printing.

The viscoelastic properties, e.g., rheological properties, of linear polymers vary with molecular weight. An entanglement refers to a point of intermolecular junction of a polymer chain entangled, overlapped, etc. with at least two other polymer chains, and thus a polymer having numerous entanglements forms a 3D network of entanglements that affects the rheology of the polymer. Accordingly, polymers having higher molecular weights tend to have an increased likelihood of entanglement interactions that results in notable effects on the rheology of the polymer, such that viscosity of a polymer rises with increasing molecular weight. Typically, an entanglement molecular weight Mₑ is defined as the average molecular weight of a chain segment between intermolecular junction points. For a polymer having a molecular weight below twice the entanglement molecular weight, that is below a minimum chain length needed to form entanglement networks, the low shear rate melt viscosity of the low molecular weight polymer may be proportional to the molecular weight. At molecular weights significantly above twice the entanglement molecular weight, the low or “zero” shear rate melt viscosity of the linear polymer scales with molecular weight to a power of 3.4. The flow properties of a polymer are disrupted by entanglement points (e.g., intermolecular junctions), and thus for a polymer at a given molecular weight, the inflection point representing the transition of flow of the polymer from a dependence on whole molecular flow to a dependence on the motion between entanglement points represents the entanglement MW.

In one embodiment, a polyolefin-based ink for additive manufacturing includes a polyolefin having a molecular weight no more than five times the entanglement molecular weight Mₑ of the polyolefin, where the polyolefin includes at least one type of functional group for crosslinking. In preferred approaches, the polyolefin has a molecular weight no more than twice (2×) the entanglement molecular weight Mₑ of the polyolefin. In some approaches, the polyolefin may have a molecular weight no more than 5 times the entanglement or critical molecular weight.

In some approaches, a polyolefin having a molecular weight at least 5× below the entanglement molecular weight may allow the flow of the pure polymers as liquids having “Newtonian” rheology, e.g. a constant viscosity as a function of flow rate. Such materials do not generally have significant viscoelasticity up to moderate stresses (e.g., 1 MPa), which is important in the final formulation to prevent elasticity driven die swell during DIW fabrication. Without wishing to be bound by any theory, it is believed that there is a specific level of stress independent of rate as demonstrated by the shear stress at the transition from the Newtonian plateau of the melt to the shear thinning region of the melt flow cure (Viscosity versus rate).

In one exemplary approach, an ink includes a polyolefin having a low molecular weight MW of less than 20,000 and preferably less than 10,000. A low MW may allow the ink to have a low viscosity to extrude a printable material by DIW process. For example, a preferred ink may have a viscosity that allows extrusion of a paste-like material through a nozzle and has appropriate low viscosity that the flowing does not build up excessive pressure during the forming of a layer. In preferred approaches, the MW of a polyolefin is below the entanglement molecular weight Mₑ or within a factor of 2 of the Mₑ of the polymer.

In preferred approaches, a polyolefin includes ethylene and propylene monomeric units. The molecular structure of an ethylene monomeric unit forms a series of C—C bonds with two hydrogens on each carbon in the polymer, such that the majority of the mass of the ethylene monomeric unit is within the chain backbone of the polyolefin. As generally understood, several factors of ethylene including the C—C backbone, small size and mass of the pendant hydrogen atoms on ethylene, and lack of significant dipole or hydrogen bonding may account for a very low glass transition in polyethylene. However, pure polyethylene is also able to crystallize with an equilibrium melting point of approximately 140° C. Addition of comonomers such as propylene disrupt the ability of the polyethylene sequences to crystallize by sterically blocking the ordering of the material into crystals. However, the addition of propylene or other monomers may also affect the glass transition temperature of the polyolefin.

In the preferred approaches, polyolefin-based inks include an ethylene-containing polyolefin having a composition designed to minimize the glass transition temperature of the polyolefin while suppressing ethylene crystallinity. An optimal composition of ethylene in the polyolefin may allow a preferred lower temperature capability of the polyolefin material. Moreover, the covalent C—C bonds of the backbone of the polyolefin provides a hydrolytic stability to the polyolefin in terms of resisting hydrolysis or cleavage from exposure to acids or bases. In addition, an ink including a polyolefin may be hydrophobic, having a low moisture content, etc.

In various approaches, a polyolefin includes a composition of an ethylene monomeric unit and at least one different monomeric unit having a property different from ethylene, e.g., lowering glass transition temperature of the cured polyolefin, adding polarity, etc. For example, a polyolefin may include a vinyl acetate monomeric unit for providing a pressure sensitive adhesive property in the resultant product. For example, an ethylene vinyl acetate polyolefin may form product such as a pressure sensitive adhesive which could be cured into a “gel-like” state, e.g. with very low diene content. Moreover, adjusting the composition toward a higher ethylene content (versus vinyl acetate content) may provide the crystallization properties of ethylene resulting in a material with shape memory behavior, e.g., having a function of a hot melt adhesive.

In one approach, a material formed of a polyolefin having an acetate group has a polarity that may be useful for incorporating various fillers into the material, such as for example, metal particles to provide a property of conductivity.

In one approach, a polyolefin may generally include an aliphatic olefin monomer in which the carbon atoms of the monomer form open chains, e.g., alkanes, and not aromatic rings. In some approaches, the monomeric unit may be referred to as a comonomer when used in the context of part of a copolymer. Examples of monomeric units included in a polyolefin include ethylene, propylene, butene, pentene, hexene, heptene, octene, vinylacetate, acrylic monomers such as methylacrylate, ethylacrylate, propylacrylate, n- and t-butylacrylate, pentylacrylate, hexylacrylate, methylmethacrylate, cyclohexylmethacrylate, and isobutylene, isopentene, isoprene, chloroprene, etc. In some approaches, an aliphatic olefin monomer may include higher alkenes having a progression of carbons in the alkene molecule above eight carbons, e.g., octene. In preferred approaches, an optimal length of an aliphatic alkene is in a range of ethylene to octene. Moreover, in some approaches, an aliphatic olefin monomer may include higher acrylates having a progression of carbons in the acrylate molecule above eight carbons, e.g., octyl acrylate.

In various approaches, a polyolefin includes a combination of the monomeric units, e.g., such as described herein. In preferred approaches, a polyolefin includes at least two different monomeric units. In one exemplary approach, a polyolefin includes ethylene and propylene.

In some approaches, formulations of polyolefin-based inks may include ethylene monomers in combinations of binary pairs (e.g., with diene), terpolymers, multi-monomer mixes, etc. that may be designed, engineered, tailored, etc. to optimize the low temperature behavior of the ink and cured product. In some approaches, adding side groups to a monomeric unit, e.g., monomer, of a polyolefin may disrupt packing of the polymer chains to form crystalline lattices. For example, a propylene monomeric unit has a methyl side group that tends to confound crystallization causing a free energy effect. In various approaches, a polyolefin including a monomer having specific types of side groups may further aggravate that chain packing. Thus, to optimize for steric considerations and free energy effect, a terpolymer, e.g., including three or more monomers in the polyolefin, may increase entropy in the system and decrease crystallization temperatures by affecting the free energy of mixing.

In some approaches, a polyolefin may include branched monomeric units, for example, iso-propylene, isobutylene, some of those iso monomers n-propylene, iso-propylene, n-butene, iso-butene, 1-butene, 2-butene, etc.

In preferred approaches, a polyolefin includes at least one type of functional group for crosslinking. In various approaches, a polyolefin includes a type of functional group capable of reacting with a crosslinking agent or other polymer to form crosslinks to form a network structure and, therefore, elasticity. In some approaches, the desired level of cross-linking may be specific to each application of the present polyolefin-based ink formulation. For instance, a desired degree of material stiffness may be tuned by a defined degree of crosslinking, e.g., a material stiffness increases with increasing degree of crosslinking. In various approaches, the distribution of reactive functional groups (e.g., vinyl groups) in a polyolefin may tune the desired level of cross-linking.

In various approaches, exemplary types of functional groups for crosslinking include vinyl groups, oleyl functional groups, hydroxyl groups, amine groups, epoxy groups, thiol groups, protected carbamate groups, carboxylate groups, xylene groups, xylenol groups, etc. In a preferred approach, a polyolefin may include diene monomeric units, e.g., comonomers, to provide residual vinyl groups for crosslinking. Examples of diene monomers include diene monomers generally known by those skilled in polymer chemistry.

In some approaches, an ink may include a polyolefin having different diene monomeric units, e.g., diene monomers. In one approach, a concentration of the diene monomeric unit may affect the crosslink activity of the monomeric units and the stiffness of the material after curing. The diene monomeric units may determine the crosslink sites of the material, for example, some diene monomeric units have more available vinyl groups for crosslinking. By tuning the amount of diene monomeric units in the polyolefin, the stiffness of the cured product may be tuned in terms of extent of crosslinking.

In one embodiment, a polyolefin includes an ethylene monomeric unit, a propylene monomeric unit, and a diene monomeric unit. In one approach, a concentration of the ethylene monomeric unit may be in a range of greater than 50 wt. % to about 75 wt. % of a total weight of the polyolefin. In one approach, a concentration of the propylene monomeric unit may be in a range of greater than 25 wt. % to about 50 wt. % of the total weight of the polyolefin. In one approach, a concentration of the diene monomeric unit may be in a range of greater than 0 wt. % to about 10 wt. % of a total weight of the polyolefin.

In some approaches, different physical properties of the ink and resulting product may be optimized by tuning the composition of the polyolefin. In one approach, two different properties may be tuned by two different monomers of a polyolefin. For example, the monomer composition of a polyolefin may be tuned, tailored, etc. to provide low temperature flexibility that suppresses crystallization, thermal transition, etc. of the ink during extrusion-type printing while minimizing the glass transition temperature of the cured product.

In one approach, a polyolefin-based ink may have low temperature capability by using an ethylene-propylene ratio optimized to provide no crystallinity while minimizing the glass transition temperature of the material, where the glass transition temperature is a temperature at which the polyolefin-based product transitions from a rubbery solid into a glassy solid. For example, in one approach, the ratio of ethylene and propylene of the polyolefin may be tuned to ensure substantially no crystallinity (tuning the amount of propylene) of the ink and to minimize the glass transition temperature of the product (tuning the amount of ethylene).

In one example, a polyolefin having an amount of ethylene in a range of 50 wt. % to 75 wt. % of the total weight of the ink. In some approaches, a polyolefin has an amount of ethylene that lowers the glass transition temperature (T_{g}) of the cured product to below −40° C. In preferred approaches, a polyolefin has an amount of ethylene that lowers the glass transition temperature (T_{g}) of the cured product to below −60° C.

In some approaches, a polyolefin has an amount of ethylene that may provide a minimum use temperature of the cured product of about −40° C., e.g., the lowest temperature of application of the product where the product remains elastomeric, rubbery, etc. For example, the cured product remains elastomeric at temperatures less than −40° C. In exemplary approaches, a polyolefin has an amount of ethylene that provides a minimum use temperature of the cured product of less than about −60° C. In an exemplary approach, the cured product remains elastomeric at temperatures less than −56° C.

In contrast, an ink that forms a product having a glass transition temperature (T_{g}) above −40° C. would restrict the use of the formed product at temperatures below −40° C. For example, a product having a T_{g} above −40° C. would transform from a rubbery elastomer to a glassy product at temperatures below −40° C.; thus, the product would not be useful in applications in which an elastomeric behavior of the product is essential temperatures below −40° C.

In one approach, sequentially decreasing the ethylene content less than 50 wt. % in the polyolefin may lead to a coincident increase in the glass transition temperature (T_{g}) of the cured elastomer and the useful temperature increases above −60° C.

Alternatively, if an amount of ethylene in the polyolefin is above a recommended range, and the ethylene monomer content is higher relative to the propylene monomer content, then the ethylene may induce crystallization of the polyolefin such that crystalline lattices form within the polyolefin. Moreover, the melting temperature of the crystalline lattices tend to be high, thereby limiting the use temperature of the product. For example, at concentrations above about 75 wt. % ethylene in the polyolefin, the formed product may crystallize and limit the ability of the product to retain elastomeric behavior at low temperatures. In preferred approaches, a concentration of the ethylene monomeric unit may be in a range of greater than 50 wt. % to about 75 wt. % of a total weight of the polyolefin.

In another approach, an ink includes a polyolefin that may be tuned to have partial-crystallinity for the formation of shape memory polymers that may be used in shape memory applications. In one approach, polyolefin-based ink formulation having an ethylene-propylene composition may allow for ethylene segment crystallization in the temperature range of about 20° C. to about 100° C., while simultaneously being able to be covalently crosslinked via a radical curing process. In a preferred approach, the polyolefin-based ink may have a crystallization temperature in a range of about 40° C. to about 60° C.

In various approaches, products formed as described herein may have thermal shape-memory behavior. For example, an ink may include a polyolefin that has a crystallization temperature above ambient conditions. Thus, warming the ink to temperatures above ambient or room temperature would allow the ink to be extruded at non-crystalline form, and then as the temperature returns to the lower temperature at ambient conditions, pseudo-crosslinking or partial-crystallization would occur in the material to hold the shape.

From a shape memory point of view, an ink having partial-crystallinity may allow maintenance of a temporary structure in the temperature range at ambient temperatures, and then the partial-crystallinity may be tailored to form a sharp transition temperature, for specific actuating at a certain temperature. In various approaches, the polyolefin sequence distribution may be tailored, e.g., tuned, to have enough longer sequences of the crystallizable monomer, e.g., ethylene monomeric units, such that the ethylene sequences would be long enough to so the ink could be extruded at a higher temperature above the crystallization temperature, and then the product would crystallize at the application temperature, below crystallization temperature, and provide the shape memory. For example, at an application temperature range of ambient temperature, below the crystallization temperature, a sequence distribution may be designed such that a fraction of the material can crystallize at 50° C., so it would crystallize below 50° C. and above 50° C. the material would melt.

In preferred approaches, the partial crystallization of the material is approximately 50% of the material is crystallized. In some approaches, a typical range of partial crystallization of a material may be about 5% to about 25% crystallization of the material to achieve the shape memory effect of relatively soft material.

The melting point of a polyolefin is related to crystalline size of the polyolefin which in turn is related to length of ethylene sequence. The partially crystalline characteristic of a polyolefin-based material may be tuned for a desirable percent crystallinity relative to amount of ethylene and length of ethylene sequence. In one approach, a preferred percent crystallinity of the partially crystalline ink includes a composition range of ethylene to propylene monomeric units having a ratio of about 3 to 6 wt. % ethylene to 1 wt. % propylene. For example, for crystallization of a polyolefin-based ink above room temperature, a polyolefin preferably may include a ratio of 8 to 10 wt. % ethylene to 1 wt. % propylene of the total weight of the polyolefin. In terms of a mole basis of monomeric unit, crystallization of a polyolefin above room temperature may include a ratio of about 6 to 12 ethylene monomeric unit to 1 propylene monomeric units.

In some approaches, a polyolefin-based ink may be formulated in terms of specific polymer sequence engineering, components, etc. for extrusion-based printing of a hydrophobic, low temperature capable, stiffness-controlled elastomeric material. In one approach, polyolefins may be engineered using polyolefin synthesis utilizing methods such as ring opening metathesis polymerization (ROMP) and its relatives enable control over sequence distribution and placement of crosslinking sites in the oligomeric chains. Site-specific polymerization procedures, e.g., using catalysts, etc. allow tailoring of a sequence distribution of a polymer such that the sequences may be long, short, branched, etc., sequences may be statistically engineered, crosslinking monomeric units may be placed in engineered location, etc.

According to one embodiment, an ink having a polyolefin as a networking base resin includes additives for imparting specific functionality to the resultant product. For example, in one approach, an additive to the ink may include a metallic filler to add conductivity to the product. In another approach, an additive to the ink may include magnetic particles to allow fabrication of magnetically responsive materials. In one approach, blending magnetorheological and/or electrorheological particles into the polyolefin ink formulation for DIW may facilitate post printing mechanical tailoring of the formulation. The mechanical tailoring allows re-orientation of particles post print and pre-cure to orient or form bridges.

In approaches for applications for medical devices, for example, an additive of the ink may include an anti-coagulant, a radiopaque filler for imaging, a silver compound to hinder bacterial attack for self-sterilization.

In some approaches, the ink may include components for imparting porosity in the product, for example, physical or chemical blowing agents, fugitive materials (materials that can later be removed but leaving the matrix polymer intact), microballoons, etc. In some approaches, materials can be blended during DIW printing to create porous materials with varied composition.

In various approaches, additives to the ink may include particulates, reinforcing fillers and/or fibers, crosslinker (multifunctional compounds), curing agent, rheology modifiers, dispersants, surfactants, dyes or pigments, curing agents, cure accelerators, etc. In one approach, the ink formulation may include hydrophobic emulsion particles as reinforcing fillers to form a composition of a polyolefin-based ink having high hydrophobicity.

In one approach of the ink, the filler may include a fumed silica. In various approaches the filler is present in the ink at about 5 wt. % to about 50 wt. % relative to the total weight of the ink, and preferably in a range of about 10 wt. % to about 30 wt. % of total weight of the ink. In some approaches, silica fillers with reduced surface area allow an increase degree of silica loading without over-saturating the liquid ink matrix, and thereby resulting in highly stiff printable polyolefin materials.

In some approaches, the filler may include a hydrophobic (treated) fumed silica. In other approaches, the filler may include a hydrophilic (untreated) fumed silica. In one approach, the filler may include a combination of both hydrophobic and hydrophilic fumed silica. Without wishing to be bound by any theory, advantages of including both hydrophobic and hydrophilic fumed silica in a single ink composition include a) hydrophobic silica provides lower viscosity when compounded but not thixotropy, and b) the use of a hydrophilic silica may provide sufficient thixotropy without the addition of a thixotropic additive. In some approaches, an ink may include only a hydrophilic fumed silica that provides sufficient thixotropy with the polyolefin such that the polyolefin-based ink may not need a rheology modifying additive (e.g., a thixotropic additive).

In one approach, the refractive index of the polyolefin may be matched with the refractive index of the reinforcing filler to achieve optically clear DIW-capable polyolefin-based inks.

In one approach, the ink formulation may include mechanochromic molecules to achieve sensing of the state of deformation or stress in the resulting extruded product.

In some approaches, the ink may include additives to adjust the thixotropic nature of the ink. In one approach, an additive may include solid materials, silicone, etc. In one approach, the additive may include a filler. In a preferred approach, the filler is hydrophobic to maintain the hydrophobicity of the material. In one approach, the additive may include a block copolymer as a rheology modifier.

In some approaches, the polyolefin-based ink may include a silanol functional curing agent. In one approach, the polyolefin-based ink may include a crosslinking catalyst. In some approaches, the crosslinking catalyst may utilize hydrosilylation chemistry during the curing of the 3D structure, such as a platinum crosslinking catalyst (e.g., Karstedt Pt catalyst), ruthenium crosslinking catalyst, iridium crosslinking catalyst, and/or rhodium crosslinking catalyst. In some approaches, platinum-catalyzed hydrosilylation chemistry may be used to cure the structured formed with polyolefin-based inks. In other approaches, ruthenium-catalyzed hydrosilylation chemistry may be used to cure the structures formed with polyolefin-based inks. In yet other approaches, iridium-catalyzed hydrosilylation chemistry may be used to cure the structures formed with polyolefin-based inks. In yet other approaches, rhodium-catalyzed hydrosilylation chemistry may be used to cure the structures formed with polyolefin-based inks.

In some approaches, it is advantageous to use platinum (Pt)-group metal-catalyzed hydrosilylation chemistry because the process does not generate volatile reaction products as compared to condensation cure reactions that produce byproducts such as acetic acid, ethanol, etc. Moreover, these byproducts could deleteriously contribute to some material shrinkage and deviation from the form of the printed 3D structure as deposited.

In some embodiments, the polyolefin-based ink may include a Pt-group metal crosslinking catalyst involved in metal catalyzed hydrosilylation chemistry, at a concentration in the range of about 1 to about 1000 ppm, and preferably in a range of about 1 to about 100 ppm, and ideally, 1 to about 50 ppm. In some approaches, the polyolefin-based ink may include an effective amount of Pt-group metal to initiate a metal-catalyzed hydrosilylation chemistry curing reaction at pre-defined curing conditions, e.g., a pre-defined elevated temperature.

In some embodiments, the polyolefin-based ink may include an effective amount of an inhibitor for controlling a rate of curing by the crosslinking catalyst under ambient atmospheric conditions, e.g., for increasing pot life duration. In one approach, an amount of inhibitor may be in the range of greater than 0 to about 1 wt. % of the total ink. In some approaches, the inhibitor may be selected based on the crosslinking catalyst. In some approaches, to maximize the printing time before cure (for example, delay the curing reaction as long as possible), an appropriate choice of a reaction inhibitor relative to the crosslinking catalyst may be added to inhibit platinum-catalyzed curing chemistry, thereby providing a prolonged pot life duration for extended 3D printing sessions.

In some embodiments, polyolefin-based inks may be formulated to yield two-part materials in predetermined ratios. For example, Part A may include a polyolefin, a hydrophobic reinforcing filler (e.g., fumed silica), a rheology modifying additive, and a crosslinking catalyst; and Part B may include a crosslinking agent (PHMS), crosslinking catalyst inhibitor, and an additional amount of polyolefin to create a 10:1 2-part A:B system. In some approaches, Part A may be assembled and then may be stored until use. Part B may be assembled and then stored until use. In other approaches, Part A and Part B may be assembled separately and used immediately.

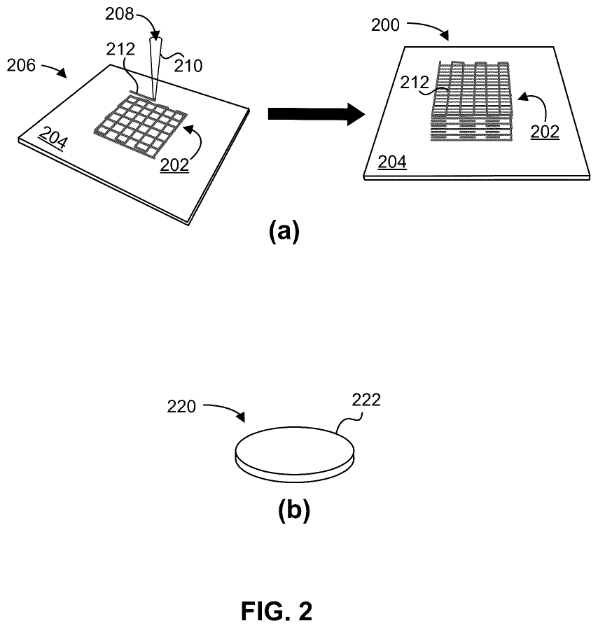

FIG. 2 depicts structures 200 and 220 of polyolefin-based matrix, in accordance with one embodiment. As an option, the present structures 200 and 220 may be implemented in conjunction with features from any other embodiment listed herein, such as those described with reference to the other FIGS. Of course, however, each structure 200 and 220 and others presented herein may be used in various applications and/or in permutations which may or may not be specifically described in the illustrative embodiments listed herein. Further, each structure 200 and 220 presented herein may be used in any desired environment.

According to one embodiment, a product of additive manufacturing with a polyolefin-based ink includes a 3D structure having an extruded continuous filament arranged in a predefined pattern. The continuous filament is comprised of a polyolefin matrix having a microstructure, where the microstructure is retained after curing. In one approach, the polyolefin matrix includes an ethylene monomeric unit, a propylene monomeric unit, and a diene monomeric unit.

Part (a) of FIG. 2 illustrates a schematic diagram of a 3D structure 200 having polyolefin-based matrix 202 formed by extrusion-based DIW printing 206. A polyolefin-based ink 208 may be extruded through a nozzle 210 onto a substrate 204 in one continuous extruded filament 212 to form a 3D geometric structure 200 (e.g., log pile, computer-aided design (CAD), etc.).

Part (b) of FIG. 2 illustrates a bulk structure 220 of a polyolefin-based material 222. A bulk structure 220 may be formed by casting the polyolefin-based ink in a mold prior to curing.

In one approach, the microstructure may include a plurality of intra-filament pores formed from a porogen, microballoons, gas-blowing agents, etc.

In various approaches, the product having a polyolefin matrix is resistant to chemical degradation, e.g., having hydrolytic stability. For example, elastomer polyolefin products may be resistant to degradation by moderate to strong bases or acids in applications. Moreover, in various approaches, a product formed by a polyolefin-based ink may maintain functionality and resist degradation in a caustic chemical environment, e.g., acidic, basic, etc. over an extended duration of time, e.g., years, 10s of years, etc.

In some approaches, a polyolefin-based structure formed from a polyolefin-based ink may have an operating temperature in a range of −40° C. and up to 200° C., or some subrange therebetween according to its composition.

In one approach, the polyolefin matrix of the product includes magnetic material.

In one approach, the polyolefin-based product has thermal shape-memory behavior.

In one approach, a product having a polyolefin matrix may be resistant to radiation degradation.

In one approach, a product having a polyolefin matrix has increased strength compared to a silicone matrix. Without wishing to be bound by any theory, it is believed that the C—C bond in the backbone of the polyolefin matrix offers greater rigidity and stability compared to the Si—O bond in the backbone of a silicone matrix. In exemplary approaches, a polyolefin-based ink without reinforcing additives forms a product of increased mechanical strength compared to a silicone-based ink having reinforcing additives.

According to one embodiment, the polyolefin-based 3D structure has physical characteristics of formation by additive manufacturing. In one approach, direct-ink-writing (DIW) affords the possibility of creating fine physical features (<1 mm) with single and multicomponent features not attainable by standard polymer casting methods. In one approach, a polyolefin-based 3D structure may have a physical property of being rigid and the cured extruded continuous filament forms a unique-shaped structure. A unique-shaped structure may be any structure that does not have a conventional shape (e.g., cube, cylinder, molded shape, etc.). In some approaches, a shape of a unique-shaped structure may be defined by a user, a computer program, etc.

In some approaches, the architectural features of the formed polyolefin-based 3D parts may have length scales defined by specific AM techniques. For example, features may have length scales in a range between 0.1 micron (μm) to greater than 100 μm, depending on the limitations of the AM techniques. In various approaches, AM techniques provide control of printing features, ligaments, etc. of 3D structures having length scales in a range between 0.1 μm to greater than 100 μm, and more likely greater than 10 μm. Further, a UV-curable functionality lends itself to light-driven AM techniques, including projection micro-stereolithography (PuSL) and direct laser writing via two photon polymerization (DLW-TPP). Stereolithography-based AM techniques are notable for high throughput, fine features, and detailed prototyping. Even higher resolution can be achieved with DLW-TPP, which can produce ligaments on the order of 100 nm.

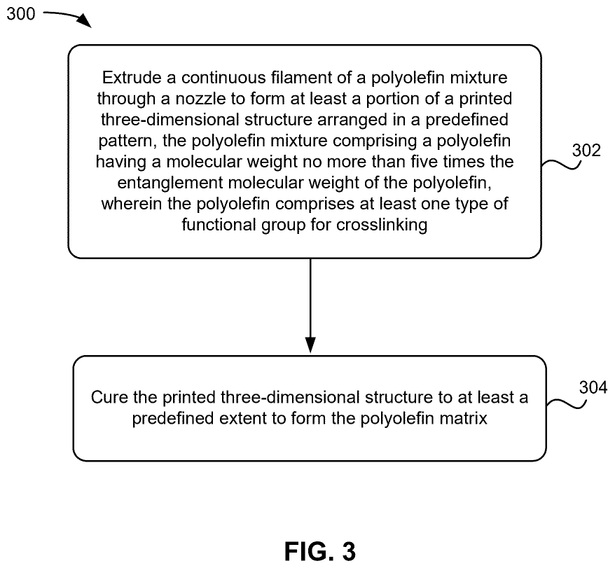

FIG. 3 shows a method 300 of forming a 3D structure including a polyolefin-containing matrix, in accordance with one embodiment. As an option, the present method 300 may be implemented to construct structures such as those shown in the other FIGS. described herein. Of course, however, this method 300 and others presented herein may be used to form structures for a wide variety of devices and/or purposes which may or may not be related to the illustrative embodiments listed herein. Further, the methods presented herein may be carried out in any desired environment. Moreover, greater or fewer operations than those shown in FIG. 2 may be included in method 300, according to various embodiments. It should also be noted that any of the aforementioned features may be used in any of the embodiments described in accordance with the various methods.

According to one embodiment, the method 300 begins with step 302 involving extruding a continuous filament of a polyolefin mixture through a nozzle to form at least a portion of a printed 3D structure arranged in a predefined pattern. The polyolefin mixture includes a polyolefin having a molecular weight no more than five times the entanglement molecular weight of the polyolefin. The polyolefin includes at least one type of functional group for crosslinking. The polyolefin mixture may be an ink, resin, etc.

In one example, a polyolefin may be obtained having a molecular weight that is characterized as having a viscosity in a range of 50 mPa*s to 500,000 mPa*s. Preferably, a polyolefin has a molecular weight that is less than 5× the Mₑ of a series of homologous series of the polyolefin, the Me being calculated based on the zero shear viscosity of a homologous series of the polyolefin.

In some approaches, a polyolefin includes an ethylene monomeric unit, a propylene monomeric unit, and a diene monomeric unit. In one approach, A concentration of the ethylene monomeric unit may be in a range of about 50 wt. % to about 70 wt. % of a total weight of the polyolefin. In one approach, a concentration of the propylene monomeric unit may be in a range of greater than 25 wt. % to about 50 wt. % of a total weight of the polyolefin. In one approaches, a concentration of the diene monomeric unit may be in a range of greater than 0 wt. % to about 10 wt. % of a total weight of the polyolefin.

In one approach, the polyolefin-based ink may have a crystallization temperature in a range of about 40° C. to about 60° C. The polyolefin-based ink may be partially crystalline at temperatures below 40° C.

In some approaches, step 302 may include adding to the polyolefin mixture a crosslinking catalyst and/or a crosslinking agent. In one approach, the crosslinking catalyst and/or crosslinking agent may be added to the ink in the cartridge of the extrusion device. Alternatively, the crosslinking catalyst and/or crosslinking agent may be part of a premade mixture that is fed through the cartridge.

In yet other approaches, step 302 may include adding to the ink an effective amount of an inhibitor for controlling a rate of curing by the crosslinking catalyst. In one approach, the inhibitor may be added to the ink in the cartridge of the extrusion device. Alternatively, the inhibitor may be part of a premade mixture that is fed through the cartridge.

In some approaches, the polyolefin mixture includes a porogen.

In some approaches, step 302 includes extruding the ink through the cartridge to form a structure. In various approaches, the presence of a rheology modifying additive may impart pseudoplasticity to the polyolefin-based ink such that the compression stress of the ink in the cartridge allows the ink to be extruded from the cartridge during 3D printing.

In this and other embodiments, the ink may be extruded by a direct ink writing (DIW) device. In one approach, the ink may be extruded from a nozzle. In one approach, the ink may be added to a cartridge and the cartridge may include a nozzle. The ink may initially be in two parts (e.g., Part A and Part B) and may be combined (e.g., mixed) in the nozzle, where one or more of the components is added to the nozzle separately from the other components. A mixer may provide mixing within the nozzle. In another approach, the ink may be premade and fed to the nozzle.

The rheology of the ink is such that it exhibits low yield stress for ease of extrusion in DIW and achieves a high enough zero shear viscosity after extrusion that the ink maintains its extruded shape and does not sag across spanning features. Deposited layers of ink retain their printed shape and the shape of the overall printed structure for prolonged periods of time prior to curing. Alternatively, when it is desired that non-porous articles are fabricated the inks can be formulated to be flowable or “self levelling”, displaying a Newtonian viscosity at low stress.

The DIW process relies upon a material having a highly thixotropic or yielding behavior when stress is applied. For example, material for extrusion processes may be referred to as Bingham fluids. These materials behave as solids at very low stress levels; however, at higher stress levels these materials structurally break down and flow. On cessation of flow, the materials often regain their solid-like behavior.

A typical process of extrusion includes applying pressure to the ink in a liquid melt state to force a fit of the ink through an article, e.g., die. Shearing is involved as part of the applied force, and the applied stresses from passing through the die causes the material to disentangle and flow depending on where the stresses are applied to the molecules or entangled mixture of molecules of the passing ink material. In a case where the material is highly entangled during processing, the applied pressures tends to stretch the structure of the molecules in a specific direction as the molecules pass through the processing geometry, such as the die. Then, as the molecules leave the applied pressure of the die, the structure of the molecules relax with no external pressure being applied, and essentially recover changed to a random conformation, Since the material is stretched into a highly elongated strand during processing, the diameter of the extruded strands tend to expand as the strands relax to a lower energy random conformation. In some instances, the relaxed extruded strands may expand by a few percent of the extruding diameter through the die to up to a factor of 2 or 3 times the diameter of the extruding diameter. The expansion of the extruded strands may be referred to as die swell.

According to one embodiment, a polyolefin-based ink is extruded to form a polyolefin-based polymer matrix. In polymer processing, as described herein, die swell of the extruded strands is preferably minimized. In exemplary approaches, the diameter of the relaxed extruded strands is preferably approximately equal to the diameter of the die. In one approach, tuning a polyolefin to optimize the plug flow mechanism where the velocity of the flow is assumed to be constant through the die, may allow the material to stay in a preferable thixotropic paste-like state as the material is extruded through the die. According to one approach, by including lower MW polyolefins, as described herein, an extruding ink may demonstrate a split flow at the internal wall of the die thereby forming interfaces that have less entanglement and thus minimize the highly elongated state of the structures of the molecules during extrusion, thereby minimizing die swell.

For approaches involving extrusion-based additive manufacturing processes (e.g., DIW), the polyolefin-based ink, mixture, etc. preferably is extrudable from nozzle sizes ranging from about 100 μm to about 1 mm but could be smaller or larger.

In one approach, the forming of the 3D structure may include extruding a continuous filament of the polyolefin mixture through a nozzle to form a printed 3D structure having a plurality of continuous filaments arranged in a predefined pattern. In one approach, the predefined pattern may be a geometric pattern, e.g., a log-pile, a mesh, patterned architectures, etc.

In one embodiment, the product is a 3D printed structure having continuous filaments arranged in a predefined pattern. The structure may be formed from extrusion-based AM methods wherein continuous filaments are extruded with the polyolefin-based ink to form a predefined pattern.

In various approaches, for 3D printing of the ink composition using extrusion-based methodology, the ink composition preferably has shear-thinning behavior. Moreover, the ink composition exhibits a transition from a gel to a liquid at high shear rates. For example, in preferred approaches, the ink composition exhibits an oscillation stress of greater than about 100 pascals (Pa). In addition, in one approach, the gelled state of the extruded ink composition retains its shape to support its own weight during printing, i.e., the extruded structure is self-supporting.

In some approaches, the forming of a 3D structure includes forming a structure having a defined shape of one of the following: a mold, a cast, a template, etc. The ink may be extruded into a mold, cast, template, etc.

Step 304 of method 300 involves curing the 3D structure to at least a predefined extent to form a polyolefin matrix. In various approaches, the 3D printed structure of polyolefin mixture may be cured according to the crosslinking catalyst present in the polyolefin mixture. In some approaches, the temperature may be raised in order to initiate curing. In other approaches, UV curing may be used including UV irradiation to initiate curing of the printed structure. In yet other approaches, free radical chemistry (e.g., peroxide curing) may be used to initiate curing of the printed structure. In one approach, moisture curing may be used (e.g., a tin catalyst, ethoxy- or methoxy-terminated functional crosslinkers, etc.) to cure the printed structure with relative humidity (e.g., in a range of 5% to 95% relative humidity). In various other approaches, curing may be initiated by methods known by one skilled in the art.

After printing, the extruded polyolefin-based inks may become elastomeric, toughened, solid, etc. polymers through chemical crosslinking via curing, physical crosslinking via crystallization, phase separation, ionic interactions, etc. In some approaches, the extruded polyolefin-based ink may be cured by chemical crosslinking into a porous or nonporous structure through the reaction of residual functional side groups for crosslinking. The functional side groups for cross-linking may be distributed along the polyolefin backbone and/or are present on the polymer chain ends. The groups and the chains to which these functional side groups are attached become incorporated into the network by reacting with other residual functional side groups and/or with other crosslinker agents present in the ink via catalyst-mediated polymerization reactions, e.g., a radical chain propagation reaction.

Alternatively, in one approach, polyolefin-based inks may be extruded at elevated temperatures and allowed to cool/crystallize to achieve a solid structure. In some approaches, a polyolefin-based ink may be extruded at elevated temperatures to form a structure that is partially crystallized at ambient temperatures (e.g., physical crosslinking) and may be cured by chemical crosslinking to yield shape memory materials.

In one approach, the polyolefin-based 3D structure may be cured to at least a predefined extent to form a polyolefin matrix. In some approaches, the crosslinking catalyst may utilize hydrosilylation chemistry during the curing of the 3D structure. In one approach, the curing may occur at an elevated temperature. In one approach, a temperature of the curing may be in a range of about 30° C. to about 150° C. The conditions for curing as described herein are generally understood by one skilled in the art

In some approaches, in the absence of the reaction inhibitor, the curing mechanism involving the polymerization reaction may proceed rapidly thereby solidifying the printed part within minutes. Thus, a metal-catalyst crosslinking catalyst (for example Karstedt Pt catalyst), without reaction inhibitor may be undesirable for polyolefin-based inks involved in the printing of large parts.

In some approaches, curing the ink formulation may include thermal, ultraviolet (UV) driven peroxide curing, etc. In some approaches, the crosslinking catalyst may induce curing in response to ultraviolet radiation. In other approaches, a crosslinking catalyst may induce curing in response to free radical chemistry. In yet other approaches, the crosslinking catalyst may induce curing in response to ionizing radiation. In other approaches, the crosslinking catalyst may induce curing via moisture curing. Known crosslinking catalysts may be used in such approaches.

In optional approaches in which the polyolefin mixture includes a porogen, method 300 may include an additional step after curing of leaching the porogen from the polyolefin matrix to result in a plurality of pores forming interconnected channels through the polyolefin matrix of the 3D structure.

In one approach, a further step of method 300 may include heating the 3D structure having the polyolefin matrix for setting the polyolefin matrix.

In some embodiments, the direct application of additive manufacturing using polyolefin-based inks with tunable stiffness may allow engineering of components and parts with specific properties including both low and high potential stiffness.

### In Use

Polyolefins are inexpensive materials used in a variety of applications for their versatility, making them well-suited for DIW. In some embodiments, polyolefin-based materials with differential stiffness may be 3D printed in tandem or simultaneously to generate unique objects with novel properties that are applicable to a wide-range of fields such as, but not limited to, consumer goods, transportation, aerospace and defense, medical, packaging industries, etc. In terms of consumer goods, various embodiments may be used for shoe soles; memory foam pillows and mattresses, household and outdoor furniture; sporting goods, e.g., protective equipment; toys; camping equipment; bicycle seats, etc. Various embodiment may be used in transportation, for example, automobile parts and interior cushioning, gaskets and foam mounts, etc.

Embodiments may be used in aerospace and defense, for example seat cushioning; padding in equipment, gasketing and vibration dampening, etc.

Various embodiments described herein may be applied to 3D engineered medical devices, for example, braces for neck, ankle, etc.; stretchers; foams for wound filling/healing, etc. Various embodiments may be used for packaging, for example, protective packaging for electronics, delicate items, etc.

The inventive concepts disclosed herein have been presented by way of example to illustrate the myriad features thereof in a plurality of illustrative scenarios, embodiments, and/or implementations. It should be appreciated that the concepts generally disclosed are to be considered as modular, and may be implemented in any combination, permutation, or synthesis thereof. In addition, any modification, alteration, or equivalent of the presently disclosed features, functions, and concepts that would be appreciated by a person having ordinary skill in the art upon reading the instant descriptions should also be considered within the scope of this disclosure.

While various embodiments have been described above, it should be understood that they have been presented by way of example only, and not limitation. Thus, the breadth and scope of an embodiment of the present invention should not be limited by any of the above-described exemplary embodiments but should be defined only in accordance with the following claims and their equivalents.

What is claimed is:

1. A polyolefin-based ink for additive manufacturing, the ink comprising:
a polyolefin comprising at least one type of functional group for crosslinking,
wherein the polyolefin comprises at least an ethylene monomeric unit and at least a propylene monomeric unit,
wherein the ethylene monomeric unit is present in a range of greater than 50 weight. % to about 75 weight. % of a total weight of the polyolefin,
wherein the polyolefin has a molecular weight that is no more than five times the entanglement molecular weight of a homologous series of the polyolefin.

2. The ink as recited in claim 1, wherein the at least one type of functional group for crosslinking is chosen from a vinyl group, an oleyl group, a hydroxyl group, an amine group, an epoxy groups, a thiol groups, a protected carbamate group, a carboxylate groups, a xylene groups, and a xylenol group.

3. The ink as recited in claim 1, wherein the polyolefin comprises another type of monomeric unit chosen from ethylene, propylene, butene, pentene, hexene, heptene, oxtene, vinylacetate, acrylic monomeric units such as methylacrylate, ethylacrylate, propylacrylate, n- and t-butylacrylate, pentylacrylate, hexylacrylate, methylmethacrylate, cyclohexylmethacrylate, isobutylene, isopentene, isoprene, and chloroprene.

4. The ink as recited in claim 1, wherein the molecular weight is no more than twice the entanglement molecular weight of the polyolefin.

5. The ink as recited in claim 1, wherein the ink has a crystallization temperature in a range of about 40 degrees Celsius to about 60 degrees Celsius.

6. The ink as recited in claim 1, wherein a concentration of the propylene monomeric unit is in a range of greater than 25 weight. % to about 50 weight. % of a total weight of the polyolefin.

7. The ink as recited in claim 1, wherein the polyolefin comprises a diene monomeric unit.

8. The ink as recited in claim 7, wherein a concentration of the diene monomeric unit is in a range of greater than 0 weight. % to about 10 weight. % of a total weight of the polyolefin.

9. The ink as recited in claim 1, comprising a curing agent.

10. The ink as recited in claim 1, comprising a reinforcing filler and/or a reinforcing fiber.

11. The ink as recited in claim 1, comprising a rheology modifying additive.

12. The ink as recited in claim 1, comprising an inhibitor.

13. The ink as recited in claim 1, comprising an additive chosen from particulates, a porogen, a dispersant, a surfactant, a dye, a pigment, a physical blowing agent, a chemical blowing agent, and microballoons.

14. A polyolefin-based ink for additive manufacturing, the ink comprising:
a polyolefin comprising at least one type of functional group for crosslinking,
wherein the polyolefin has a molecular weight that is no more than 5× the entanglement molecular weight of a homologous series of the polyolefin,
wherein the molecular weight is calculated using one of the techniques chosen from number average molecular weight, weight average molecular weight, and Z-average molar mass,
wherein the ink has a crystallization temperature in a range of about 40 degrees Celsius to about 60 degrees Celsius.

15. The ink as recited in claim 14, wherein the at least one type of functional group for crosslinking is chosen from a vinyl group, an oleyl group, a hydroxyl group, an amine group, an epoxy groups, a thiol groups, a protected carbamate group, a carboxylate groups, a xylene groups, and a xylenol group.

16. The ink as recited in claim 14, wherein the polyolefin comprises at least one type of monomeric unit chosen from thylene, propylene, butene, pentene, hexene, heptene, oxtene, vinylacetate, acrylic monomeric units such as methylacrylate, ethylacrylate, propylacrylate, n- and t-butylacrylate, pentylacrylate, hexylacrylate, methylmethacrylate, cyclohexylmethacrylate, isobutylene, isopentene, isoprene, and chloroprene.

17. The ink as recited in claim 14, wherein the polyolefin comprises an ethylene monomeric unit, a propylene monomeric unit, and a diene monomeric unit.

18. The ink as recited in claim 17, wherein the ethylene monomeric unit is present in a range of greater than 50 weight. % to about 75 weight. % of a total weight of the polyolefin.

19. The ink as recited in claim 17, wherein the propylene monomeric unit is present in a range of greater than 25 weight. % to about 50 weight. % of a total weight of the polyolefin.

20. The ink as recited in claim 17, wherein the diene monomeric unit is present in a range of greater than 0 weight. % to about 10 weight. % of a total weight of the polyolefin.
